(19) United States
(12) Patent Application Publication
(10) Pub. No.: US 2011/0270142 A1
(43) Pub. Date: Nov. 3, 2011

(54) WHOLE BODY AND SPINE CHIROPRACTIC MASSAGER

(76) Inventor: Jae Lak Yang, Busan (KR)

(21) Appl. No.: 13/143,541

(22) PCT Filed: Jan. 5, 2010
(86) PCT No.: PCT/KR2010/000026

§ 371 Date: Jul. 6, 2011

(30) Foreign Application Priority Data
Jan. 6, 2009 (KR) 10-2009-0000881

(51) Int. Cl. A61H 15/00

(52) U.S. Cl. 601/115

(57) ABSTRACT

The present invention relates to whole body and spine chiropractic massagers (including retractors), and more specifically, to a whole body and spine chiropractic massager which enables accurate treatment by automatically sensing a target treatment position even if an original treatment n position that was set during the spinal retraction phase has changed, the sensing operation being performed by a sensing part attached to a user's body, or by a sensor installed at a massager or indicator lamp disposed in the bed. In particular, a whole body and spine chiropractic massager 1 according to the present invention comprises an inductive proximity sensor 4 that is selectively installed at a massager roller 3 or indicator lamp 6 disposed in a bed 2 of the whole body and spine chiropractic massager 1 in such a way as to be able to elevate and horizontally reciprocate; and a sensing part 5 formed of a metallic plate, the sensing part being removably attached to a target treatment area of a patient, such that the inductive proximity sensor 4 together with the sensing part 5 may sense a body area to be treated. Such a whole body and spine chiropractic massager of the present invention performs massage and chiropractic adjustment treatment by virtue of accurate sensing of a taret treatment area even if an original treatment area has been displaced while retracting the spine of a patient, wherein the accurate sensing is offered by an inductive proximity sensor selectively installed at a massage roller or indicator lamp disposed in the bed and of a sensing part attached to a treatment area. As such, with the present invention, accurate treatment can be effected regardless of a change in the treatment area on the bed due to the spinal retraction.

### TECHNICAL FIELD

The present invention relates to whole body and spine chiropractic massagers (including retractors), and more specifically, to a whole body and spine chiropractic massager which enables accurate treatment by automatically sensing a target treatment position even if an original treatment position that was set during the spinal retraction phase has changed, the sensing operation being performed by a sensing part attached to a user's body, or by a sensor installed at a massager or indicator lamp disposed in the bed.

### BACKGROUND ART

A number of whole body and chiropractic massagers have been provided to treat patients having spinal disease without surgery. Such spinal massagers fix a patient's ankle to a rear end of the bed, retract the spine of the patient while he/she lies in the bed and massage the spine by the movement of the massager roller along the pain region.

That is, Utility Models Nos. 302605 & 345834 which have been filed by the present inventor and granted registration have a bed which slides to retract and adjust the cervical vertebral, lumbar and lower body and simultaneously massage specific regions or the entire spine by moving a roller unit including a massage roller and selectively rotate the lower body up and down and to the left and right to thereby maximize the massage and adjustment treatment effect.

However, the whole body and chiropractic massagers including the massage roller as above have the treatment position changed during the spinal retraction phase and thus cannot massage the accurate treatment position, which requires improvement.

### DISCLOSURE

### Technical Problem

The present invention has been made to solve the problems and it is an object of the present invention to provide a whole body and spine chiropractic massager which enables accurate treatment by sensing a treatment position even if an original treatment position is changed due to the spinal retraction.

### Technical Solution

In order to achieve the object of the present invention, a whole body and spine chiropractic massager comprises a massage roller provided in a bed of the whole body and spine chiropractic massager and reciprocating horizontally and elevating, or an inductive proximity sensor installed at an indicator lamp and a sensing part including a metallic plate and attached to a treatment area to thereby sense an accurate treatment area even if the treatment area is changed during the spinal retraction phase and to maximize accuracy of treatment.

### Advantageous Effect

As described above, a whole body and spine chiropractic massager according to the present invention performs massage and chiropractic adjustment treatment by virtue of accurate sensing of a target treatment are even if an original treatment area has been displaced while retracting the spine of a patient, wherein the accurate sensing is offered by an inductive proximity sensor selectively installed at a massage roller or indicator lamp disposed in the bed and of a sensing part attached to a treatment area. As such, with the present invention, accurate treatment can be offered regardless of a change in the treatment area on the bed due to the spinal retraction.

### BRIEF DESCRIPTION OF DRAWINGS

FIG. 1 is a front view of a usage state of a whole body and spine chiropractic massager according to the present invention.

FIG. 2 is a plan view of a bed of the whole body and spine chiropractic massager according to the present invention.

FIG. 3 is a front view of the bed of the whole body and spine chiropractic massager according to the present invention.

FIG. 4 is a lateral view of the bed of the whole body and spine chiropractic massager according to the present invention.

FIG. 5 is a plan view of a whole body and spine chiropractic massager according to another exemplary embodiment of the present invention.

FIG. 6 is a lateral view of the whole body and spine chiropractic massager according to another exemplary embodiment of the present invention.

### BEST MODE

A whole body and spine chiropractic massager according to the present invention has an inductive proximity sensor installed at a massage roller provided within a bed of the whole body and spine chiropractic massager and a sensing part formed of a metallic plate and attached to a target treatment area of a patient and enables accurate treatment and adjustment of a treatment area by sensing the treatment area through the inductive proximity sensor even if the treatment area has been changed due to the spinal retraction.

Also, the whole body and spine chiropractic massager according to the present invention has an inductive proximity sensor selectively installed at an indicator lamp provided in front and rear surfaces of the bed to sense the sensing part, and has a button operating manually together with the indicator lamp so that a patient may manually push the button to adjust the elevation location of the massage roller when the target treatment area is changed.

Hereinafter, exemplary embodiments of the present invention will be described in detail with accompanying drawings.

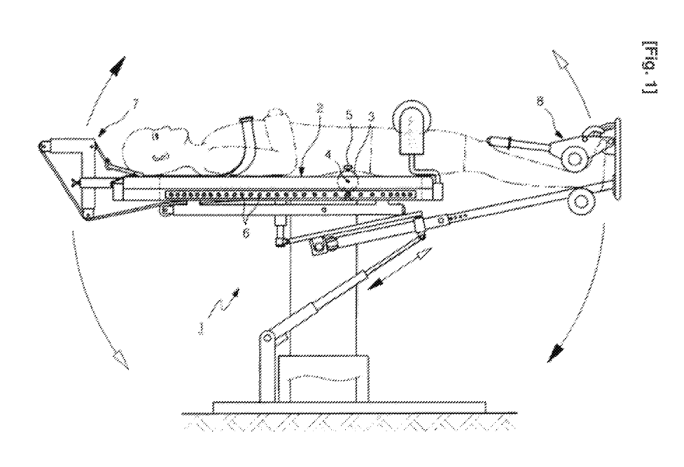

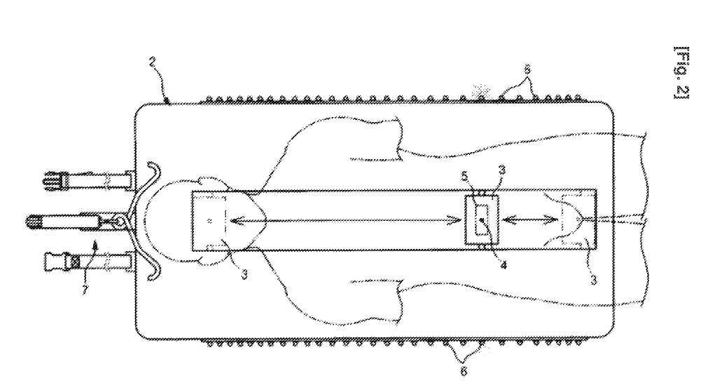

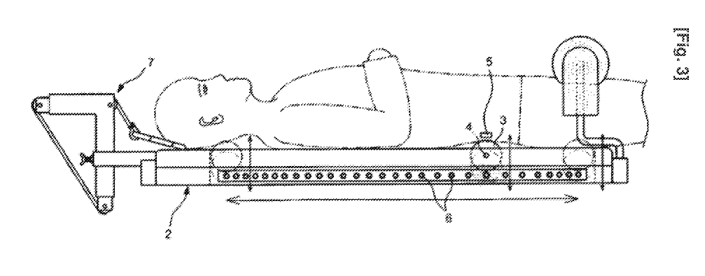

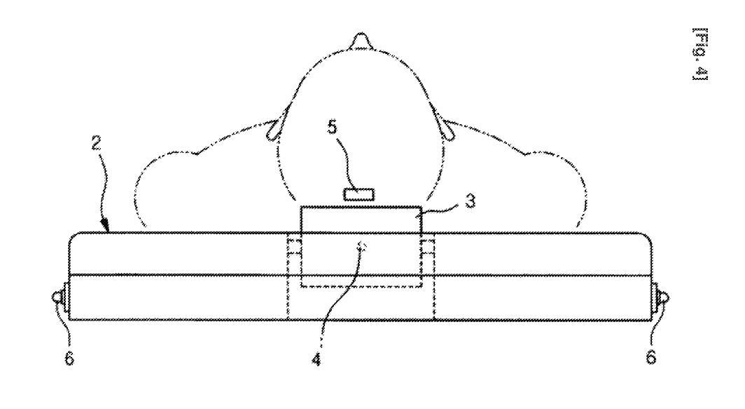

FIG. 1 is a front view of a whole body and spine chiropractic massager 1 according to the present invention. FIG. 2 is a plan view of a bed 2 of the whole body and spine chiropractic massager 1. FIG. 3 is a front view of the bed 2 exemplifying a usage state of the whole body and spine chiropractic massager 1 according to the present invention. FIG. 4 is a lateral view of the bed 2 of the whole body and spine chiropractic massager 1 according to the present invention.

The whole body and spine chiropractic massager 1 according to the present invention has an inductive proximity sensor 4 such as a high frequency oscillation proximity sensor or a magnetic sensor installed at a massage roller 3 provided within the bed 2, and a sensing part 5 including an additional metallic plate (aluminum plate, copper plate or steel plate) to be sensed by the inductive proximity sensor 4. Such sensing part 5 is attached to the back of a patient to sense the treatment area through the inductive proximity sensor 4 and to massage, adjust and treat the treatment area such as the spine.

The sensing part 5 is preferably detachably attached to the body by an adhesive tape.

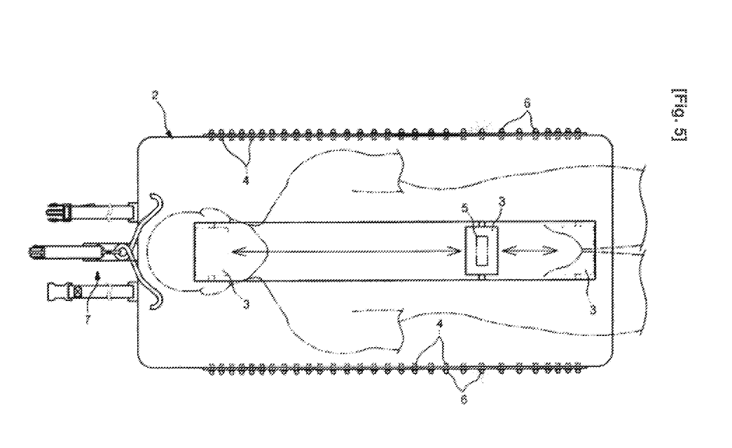

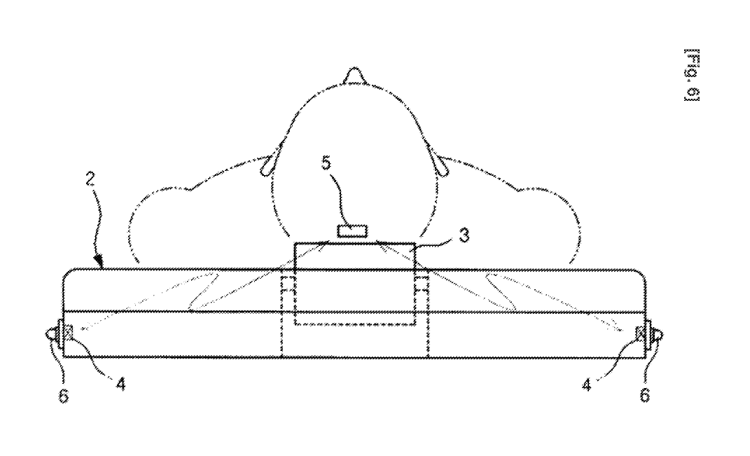

As shown in other exemplary embodiments in FIGS. 5 and 6, the inductive proximity sensor 4 may be installed at the indicator lamp 6 provided in front and rear surfaces of the bed 2, or an additional button (not shown) may be installed in the indicator lamp 6 or the button and the indicator lamp 6 may be provided as a single body so that a patient may manually turn on the indicator lamp 6 having the button as a single body and adjust the elevation position of the massage roller 3.

The whole body and spine chiropractic massager according to the present invention may be applicable to a retractor.

The reference numeral 7 in drawings refers to an upper body retracting means and the reference numeral 8 refers to an ankle fixing means.

With the foregoing configuration, the whole body and spine chiropractic massager 1 according to the present invention performs the spinal adjustment treatment by attaching the sensing part 5 to the treatment are of a patient, by connecting the upper body of the patient lying on the bed 2 to the upper body retracting means 7 as in FIG. 1 and by fixing ankles to the ankle fixing means 8.

If a patient lies on the bed 2 with the sensing part 5 attached to his/her treatment area, the sensing part 5 attached to the treatment area such as the spinal discs is sensed by the inductive proximity sensor 4 installed at the massage roller 3 provided within the bed 2 and elevating and horizontally reciprocating in a specific position to thereby perform the spinal adjustment treatment and massage by the elevation of the massage roller 3 with respect to the treatment area.

Even if the position of a patient is changed due to the spinal retraction while the massage and adjustment treatment is performed by the sequential elevation of the massage roller 3 to the cervical vertebral and the entire spine, the inductive proximity sensor 4 senses the sensing part 5 attached to the treatment area and the massage roller 3 moves to the left and right and ensures accurate treatment to the treatment area.

The inductive proximity sensor 4 installed at the massage roller 3 may be selectively installed at the indicator lamp 6 and sense the sensing part 5 attached to the treatment area to intensively treat a desired treatment area. In the case of the indicator lamp 6 having the button as a single body, a patient may manually push the button of the indicator lamp 6 and perform the spinal adjustment treatment by elevating the massage roller 3 to the desired treatment area and maximize the treatment effect.

The whole body and spine chiropractic massager according to the present invention may be applicable to not only an apparatus massaging and retracting the spine while the bed 2 is fixed horizontally, but also to apparatuses massaging and retracting the spine with inclination and retracting the spine up and down and to the left and right. Such spine retracting means may vary including the means using an additional driving means such as a connection strap or cylinder. The spine chiropractic massager may selectively employ such spinal retracting means.

### INDUSTRIAL APPLICABILITY

A whole body and spine chiropractic massager according to the present invention accurately senses a treatment area of a patient and retracts and performs adjustment treatment to the spine.

1. A whole body and spine chiropractic massager 1 comprising:
an inductive proximity sensor 4 which is installed at a massage roller 3 provided in a bed 2 of the whole body and spine chiropractic massager 1 and reciprocating horizontally and elevating; and
a sensing part 5 which comprises a metallic plate and is detachably attached to a treatment area of a patient to sense the treatment area together with the inductive proximity sensor 4.

2. A whole body and spine chiropractic massager 1 comprising:
an inductive proximity sensor 4 which is installed at an indicator lamp 6 to sense an elevation position of a massage roller 3 that is provided in a bed 2 of the whole body and spine chiropractic massager 1 and reciprocates horizontally and elevates; and
a sensing part 5 which comprises a metallic plate and is detachably attached to a treatment area of a patient to sense the treatment area together with the inductive proximity sensor 4.

3. The whole body and spine chiropractic massager according to claim 2, wherein the indicator lamp 6 comprises an additional button, or a button integrated to the indicator lamp as a single body.
